(19) United States
(12) Patent Application Publication
(10) Pub. No.: US 2020/0020060 A1
(43) Pub. Date: Jan. 16, 2020

(54) SYSTEMS, METHODS, AND INTERFACES FOR COLLECTING, ORGANIZING AND CONVEYING INFORMATION AND PREFERENCES REGARDING END-OF-LIFE ISSUES

(71) Applicant: Christopher Avery, Stamford, CT (US)

(72) Inventor: Christopher Avery, Stamford, CT (US)

(21) Appl. No.: 16/110,814

(22) Filed: Aug. 23, 2018

Related U.S. Application Data
(60) Provisional application No. 62/561,260, filed on Sep. 21, 2017.

(51) Int. Cl. G06Q 50/18; G06F 16/2457

(52) U.S. Cl. CPC G06Q 50/186; G06F 16/2457

(57) ABSTRACT

The computer-implemented systems, methods, and interfaces for collecting, organizing, and conveying information and preferences regarding certain end-of-life issues. The integrated systems, methods and interfaces guide the user to create a customized output that communicates certain information and preferences about estate planning, end-of-life issues, or final arrangements for the user, for user and their spouse, or for another third party. Inputs are solicited from the user and those inputs and other interactions are used in a decision engine to dynamically determine which queries should be presented to the user, what and how inputs are requested from the user, how the interfaces are rendered, and the ultimate content of the output. A customized output is automatically generated that organizes the user's inputs into a more productive form and combines the user's inputs with additional content and instructions. The user has the ability to print, download, or save the final output or to share the final output with a third party.

### RELATED APPLICATION DATA

This application claims priority from U.S. Provisional Patent Application No. 62/561,260, filed on Sep. 21, 2017, which application is hereby incorporated herein by reference in its entirety.

### BACKGROUND

Most people are un- or underprepared for their inevitable death. Surviving family members and friends are often ill equipped to make the decisions necessary following a loved one's passing or locate all of the information they will need to manage the decedent's affairs. Further, the process of organizing and administering an estate can be a great burden.

Even if an individual has prepared traditional estate planning documents, such as a last will and testament or trust agreement, those legal documents alone are usually insufficient to address all of the needs of the executor and surviving family members. For example, a last will and testament generally does not include instructions regarding making funeral arrangements consistent with the decedent's final wishes, help locate all of the necessary documentation or financial statements, resolve issues that are outside of the scope of the document, identifying all of the assets and liabilities of the estate, or aid in the completion of an orderly probate process. Traditional estate planning documents are not ideal for compiling information that will change from time to time because of the difficulty, time, and expense associated with creating or updating these documents.

Most people do not know all of the information and preferences that will need to be communicated to their family upon their death. Additionally, most individuals are not sufficiently equipped to identify all of the topics that must be addressed, gather all of the necessary information, organize the material in a constructive manner, and then be able to convey this information to the appropriate individuals. Preparation in advance can alleviate a great deal of burden on the decedent's family and friends.

Prior to this disclosure, an individual would have to write or type out a document that included all of the necessary information and instructions, or engage an estate planning professional to do so on their behalf. This self-directed method is limited by the knowledge of the drafter (and may not include all of the needed information), is burdensome to create and update, and may not be found or available to the individuals that need it to carry out the person's wishes. More specifically, the existing methods are limited by the knowledge of the drafter and, thus, may not include all of the information that will be needed. Even if the document is prepared by a professional, like an attorney or estate planner, the manual process is not systematic and may include gaps. Second, it can be time consuming to create and update this information oneself or to provide all of the relevant details to a third-party service advisor. Third, it is expensive to pay someone to create or update such a document on your behalf. Fourth, some of the information and instructions contained within this type of document are highly confidential and deeply personal, and an individual may not want to discuss or disclose this to a third-party advisor. These limitations, among others, prevent very many people from having this type of document in place. Additionally, estate planning professionals are often focused on purely legal documents (like a last will and testament, trust agreement, or powers of attorneys), and not this type of document that is separate from and serves a different purpose from these more formal, legal documents. Further, under the status quo this document may not be found or available to the individuals that need it to carry out the person's wishes because there are no formal mechanisms to share this document.

### BRIEF SUMMARY

The embodiments disclosed herein address the above and other needs by providing systems, methods, and interfaces that allow the user to collect, organize and share instructions, information essential to the administration of the estate, preferences regarding certain end-of-life issues and final arrangements. The embodiments herein help address these issues that are not dealt with by traditional estate planning documents and are critical to knowing and honoring the decedent's wishes. The disclosure can be used by an individual for themselves, for them and their significant other, or for another person (such as a parent, dependent adult child, family member, friend, or client). An of the embodiments herein is a customized set of instructions and information (the “Letter”) that supplements and helps fill the gaps in any existing estate planning. The collective outputs that comprise the Letter may include multiple, different artifacts that are in a tangible and/or electronic form.

As described in the embodiments herein, the content of the Letter is determined based on decisions and responses made by the user. The Letter can address a wide variety of different topics including, but not limited to, providing directions and information regarding funeral arrangements; identifying the location of important documents (e.g., last will and testament, insurance policies, financial statements); summarizing any financial accounts and insurance policies; identifying potential assets and liabilities of the estate; identifying real and intangible property; identifying professional service providers (e.g., lawyer, accountant, financial planner) and other points of contact; if permitted by the last will and testament and applicable law, listing certain personal property for disposition; providing directions regarding the access, use, and disposition of electronic assets (e.g., computer files, email, online accounts, social media, online photo libraries and backups); giving directions regarding the care of any pets; providing guidance regarding the care of any dependents; providing notifications or instructions; and including a final message to family and/or friends.

The embodiments disclosed herein provide a dynamic query-based system that guides the user to create their own customized Letter for their family or friends. The user is able to pause the process and come back later to complete the Letter. The user is also able to skip any questions that they are not able to answer or are not interested in addressing. Each section and subsection is tailored to the user based on a set of initial screening inputs and the user's responses or inputs to earlier sections. Each section and its associated queries are structured to alleviate the need for unnecessary interrogation. For example, if the user indicates that they do not have a will, they will not be asked questions about its contents or location. On the other hand, if the user indicates that they do have a will, the user will be given an option to provide inputs about, for example, the attorney that drafted the document, the named executor(s), and the location where the document is stored. Likewise, if the user does not know or have access to the requested input or does not want to provide a response, most queries can be skipped and answered later or omitted from the Letter. Inputs come in many forms including, but not limited to, text inputs, drop-down selections, multiple choice, address book, date selectors, numerical inputs, and the uploading of different media (e.g., files, documents, images). Once saved, these inputs are encrypted.

If a user returns after having not finished a Letter, the user will start where they left off. The user will be able to provide inputs to skipped sections and queries without repeating previously completed sections. Any preferences set will be remembered when the user returns to the system. The system is “responsive” so that the graphical user interface adjusts to the access device's screen size and shape—phone, tablet or larger display. The embodiments described herein may be accessed via a browser over the Internet or loaded and stored locally on the user's device.

During the workflow the system will assist the user in reviewing each completed section. The user will have the ability to provide inputs to previously skipped sections or questions. Likewise, the system will be able to generate a printable list of topics and/or questions that were skipped so that the user can follow-up on any missing or incomplete items. Prior to the completion of the Letter, the system will be able to run an audit process to help the user identify and correct potentially missing or incorrect inputs before generating a final Letter.

Once the user has completed (or skipped, if so desired) the final review and audit, the system will analyze the various inputs and will generate a customized Letter for the user. The final Letter organizes the user's inputs into a more productive form and combines the user's inputs with additional content from the system that instructs and informs the recipient of the Letter. Each Letter is unique based on the sections and subsections that the user completed and the specific inputs that the user has provided. Each Letter includes a set of instructions and a prioritized checklist to assist the recipient in the immediate aftermath of the user's or other subject's death. For example, the prioritized checklist includes recommended actions to take in the first day, first three days, first week, first month, and so on. Each checklist is customized based on the contents of the user's Letter and includes references to where additional related information can be found in the Letter.

Users are provided several options for how they can convey their final Letter to someone else. First and foremost, the user can print or save an electronic copy of their final Letter. They can share this copy or keep it in a location that is likely to be found at the time of their passing. Second, the user can give one or more trusted individuals (each a “viewer” and collectively the “viewers”) the ability to view a read-only version of the user's final Letter in the system; viewers will have near real-time access to the most current version of the Letter. A user can add or remove viewers at any time. Third, the system will support the ability to generate unique alphanumeric codes (“access code”) that will be provided to the user or transmitted at the direction of the user to give a third party access to the then-current Letter upon the user's death. Access codes can be used by the recipient to create an identity in the system to access a read-only version of the Letter; each code is single use to prevent multiple individuals from using the same code. The user will be sent a notification every time that an access code is used to create an account to access the Letter.

Periodically the user will be sent a notification to review and, if necessary, update the Letter. For each update, the user will go through a guided process to determine what information has changed and which specific sections or subsections of the Letter need to be added, removed, or revised. Like with the initial creation of the Letter, the system will determine additional queries based on the user's inputs and users will have the discretion to skip or not answer specific questions. Upon completion of any update, the system will generate an updated version of the Letter and the user will be able to print, download or share a copy of the updated Letter. Viewers that have previously been given access to the Letter by the user will have access to the updated Letter.

### BRIEF DESCRIPTION OF DRAWINGS

The above and other aspects, features, and advantages of the disclosure will be more apparent from the following more particular description thereof, presented in conjunction with the following drawings. These drawings depict only typical embodiments of the disclosure and are not, therefore, to be considered as limiting in scope, the disclosure will be described and explained with additional specificity and detail through the use of the accompanying drawings in which:

FIG. 1 shows the user flow for a new user creating their initial Letter according to an embodiment of the disclosure.

FIG. 2 shows the user flow for a returning user re-commencing their incomplete Letter according to an embodiment of the disclosure.

FIG. 3 shows the user flow for a user that is updating a Letter that was previously completed according to an embodiment of the disclosure.

FIG. 4 illustrates an example layout for when the user indicates the user type according to an embodiment of the disclosure.

FIG. 5A illustrates an example layout for when the user provides various inputs about the Letter's subject(s) (About Me) according to an embodiment of the disclosure.

FIG. 5B shows a screen from the “About Me” section with an example set of questions.

FIG. 5C shows another example question from the “About Me” section

FIG. 6 illustrates an example layout for when the user selects one or more topical sections for the Letter (Section Selection) according to an embodiment of the disclosure.

FIG. 7 illustrates an example layout for a section introduction and subsection screening page (Section Intro & Screening) according to an embodiment of the disclosure.

FIG. 8A illustrates a section question and shows examples of different input fields (Section Questions) according to an embodiment of the disclosure.

FIG. 8B shows an example question from a Letter section.

FIG. 8C shows another set of example questions from a Letter section.

FIG. 9 illustrates an example layout for the review that takes place after each section (Section Review) according to an embodiment of the disclosure.

FIG. 10 illustrates an example layout of the final review and audit that takes place after all sections are completed but before the user finishes the Letter (Final Review & Audit) according to an embodiment of the disclosure.

FIG. 11 illustrates an example layout where the user can save and/or print their final Letter and start the process to add one or more viewers (Finished Letter) according to an embodiment of the disclosure.

FIG. 12 illustrates an example layout where the user can indicate certain changes during the Letter update process (What's changed) according to an embodiment of the disclosure.

FIG. 13 illustrates an example layout where the user can add new sections or remove existing sections during the Letter update process (Add/Remove Sections) according to an embodiment of the disclosure.

FIG. 14 illustrates an example layout where the user can add or remove individuals that can view a read-only version of the then-current Letter in the system (Add/Remove Viewers) according to an embodiment of the disclosure.

FIG. 15A through 15F shows a representative sample of different pages from a compiled, final Letter.

Corresponding reference characters indicate corresponding features throughout the several different drawings according to an embodiment of the disclosure.

### DETAILED DESCRIPTION

The following description is not to be taken in a limited sense but is made merely for the purposes of describing one or more preferred embodiments. The scope of the inventions claimed should be determined with reference to the claims.

This disclosure addresses the above and other needs by providing the systems, methods, and interfaces that allow the user to collect, organize and share instructions, information essential to the administration of the estate, preferences regarding certain end-of-life issues and final arrangements. The embodiments of the disclosure help address those issues that are not adequately dealt with by traditional estate planning documents. An output of the disclosure is a customized set of instructions and information (the “Letter”) that supplements and helps fill the gaps in any existing estate planning documents. The collective outputs that comprise the Letter may include multiple, different artifacts that are in a tangible and/or electronic form.

Prior to this disclosure, an individual would have to handwrite or type out a document that included all of the necessary information and instructions, or engage an estate planning professional, attorney or another advisor to manually create the document for them. The existing methods contain a number of significant limitations. First, they are limited by the knowledge of the drafter and, thus, may not include all of the information that will be needed. Even if the document is prepared by a professional, like an attorney or estate planner, the manual process is not systematic and may include gaps. Second, it can be very time consuming to create and update this information oneself or to provide all of the relevant details to a third-party service advisor. Third, it is expensive to pay someone to create or update such a document on your behalf. Fourth, some of the information and instructions contained within this type of document are highly confidential and deeply personal, and an individual may not want to discuss or disclose this to a third-party advisor. These limitations, among others, prevent very many people from having this type of document in place. Additionally, existing estate planning professionals are often focused on purely legal documents (like a last will and testament, trust agreement or powers of attorneys), and not this type of document that is separate from and serves a different purpose from these more formal, legal documents. Further, under the status quo this document may not be found or available to the individuals that need it to carry out the person's wishes because there are no formal mechanisms to share this document. As described in more detail herein, this is a significant improvement over the status quo because it takes the user through a guided and systematic process, prompts the user to address issues that they may not be aware of, automatically tailors the process based on the user's inputs which saves time and expense, generates a final Letter that organizes and synthesizes the user's inputs with additional content, and provides a mechanism to share and update this information with family and friends selected by the user.

For the purposes of this description, “user” is a generic term to describe the person or persons that are interacting with the disclosure's systems. The user may be completing a Letter for themselves or for themselves and their significant other. A user may also be completing a Letter for another person, such as a parent, dependent adult child, family member, friend, or client. The user may be a friend, family member, or professional service provider (like an attorney, accountant, estate planning specialist or financial advisor).

The system is “responsive” so that the graphical user interface adjusts to the user's access device's screen size and shape—phone, tablet or larger display. The embodiments described herein may be accessed via a browser over the Internet or loaded and stored locally on the user's device.

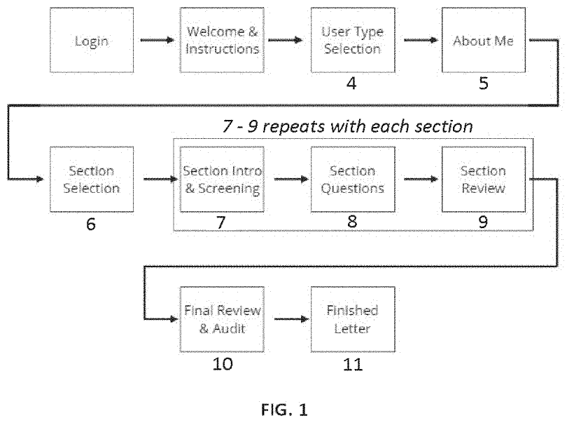

FIG. 1 shows a representative user flow for a new user creating their initial Letter. The flow illustrates the path that a typical user will take from their first login to the completion of their initial Letter. The disclosure is a dynamic query-based system that guides the user to create their own customized Letter for their family or friends. As described in more detail below, users will select their user type, provide some information about the subject of the Letter, select which topics (sections) are desired for the Letter, and then provide inputs to the selected sections. The sections and specific queries that are included in each section are based on decisions and responses made by the user while utilizing the embodiments described herein. The user is also able to skip any questions that they are not able to or interested in addressing. As suggested by next figure, the user is able to pause the process and come back later to complete the Letter.

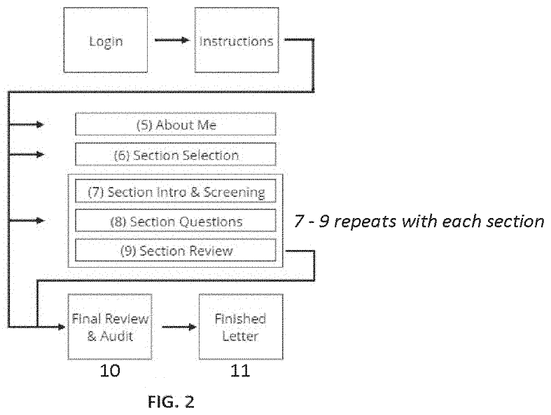

FIG. 2 shows a representative user flow for a returning user who is re-commencing their incomplete Letter. The returning user will start wherever they left off and continue with the completion of the Letter. The user will be able to provide inputs to skipped sections and queries without repeating previously completed sections. Any preferences set will be remembered when the user returns to the system. The user can stop and return multiple times. As in FIG. 1, the sections and individual queries that are included in each section during the continuation are based on decisions and responses made by the user, including interactions during prior sessions.

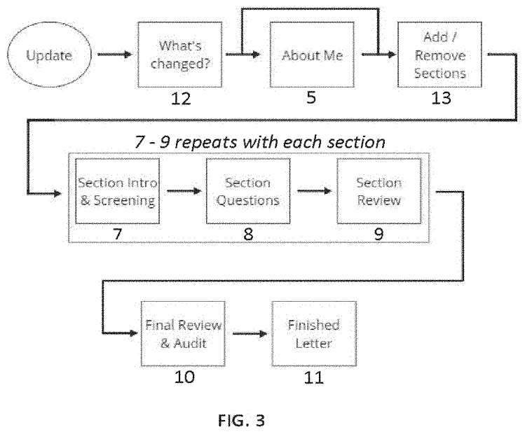

FIG. 3 shows a representative user flow for a user that is updating a Letter that was previously completed. The system will periodically send notifications to the user to remind them to review and, if necessary, update the Letter. Unlike the process to create the initial Letter in FIG. 1 and FIG. 2, the user will be directed through two separate processes to identify what has changed since the Letter was last revised and also give the user an opportunity to remove or add whole topical sections from the Letter. The system will then determine which additional queries need to be directed to the user based on these responses and other inputs the user makes into the system. Like with the initial creation of the Letter, users have the discretion to skip or not answer specific questions. As discussed in more detail below, upon completion of any update, the system will generate an updated version of the Letter and the user will be able to print, download or share a copy of the updated Letter. Visitors that have previously been given access to the Letter by the user will have access to the updated Letter.

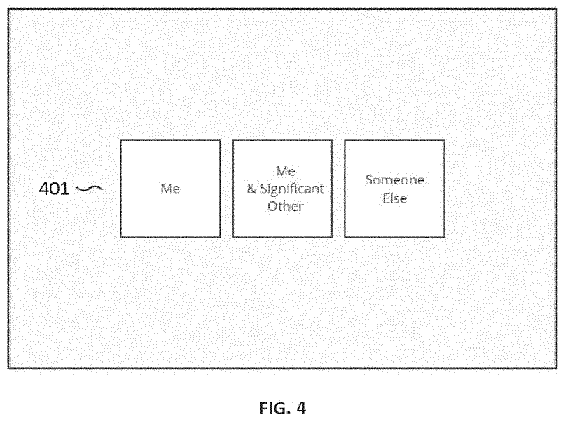

The user type selection option 401 according to the present disclosure is shown in FIG. 4. The user's selection here will determine the subject(s) of the letter: (1) the user, (2) the user and their significant other, or (3) someone else (e.g., family, friend, dependent adult child, client). This selection allows the system to appropriately frame the queries and determine which inputs should be requested for each individual. For example, a Letter for two people will ask each about their own, separate preferences in different areas.

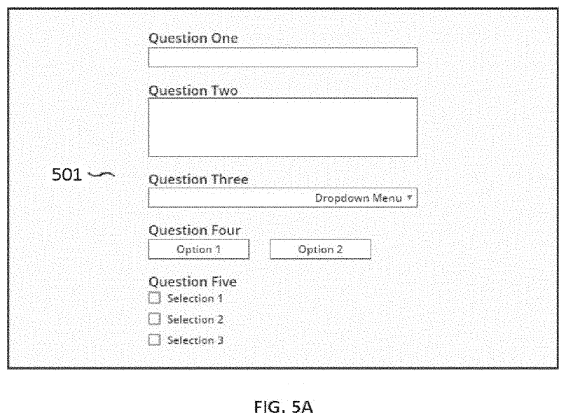

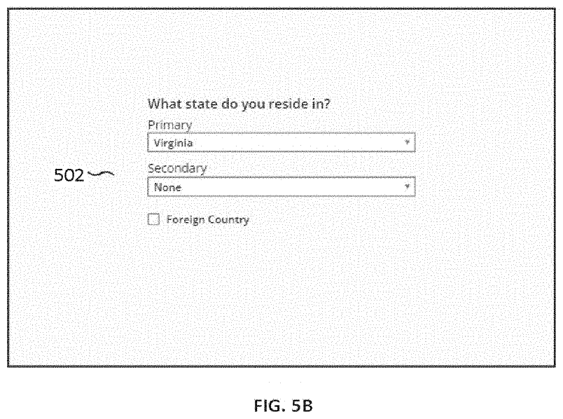

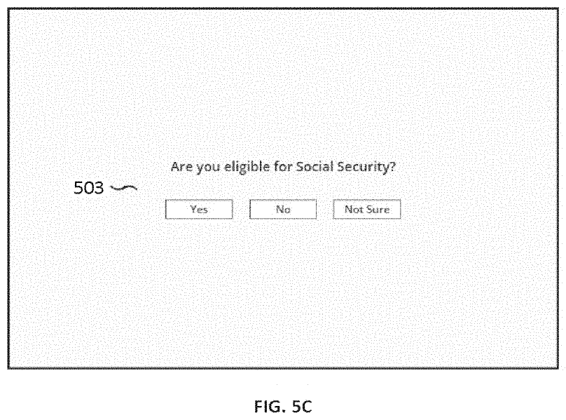

FIG. 5A illustrates an example “About Me” layout where the user provides various inputs about the Letter's subject(s). These questions gather baseline information about the user (e.g., name, location, military service, dependents) and are used to tailor other sections, subsections, and queries in the system. The inputs gathered in this part are also used to help determine what content should be included in the final Letter. For example, if the user indicates that they are a veteran, additional content about Veteran Affairs burial and other benefits are included in the Letter and in the Letter's customized checklist. The recipient of the Letter can use this information to identify and request specific benefits and arrange for military honors at the funeral service, if desired. Number 501 shows non-exhaustive, examples of different question types and input formats that may be used in this part.

Screen 502 on FIG. 5B illustrates an example question in the “About Me” section. This particular question collects the user's primary and, if applicable, secondary state of residence. Likewise, if the user resides outside of the United States, that is recorded as well. The responses to this question are utilized by the system later in the process to determine what additional sections and questions are displayed to the user and what information is included in the final Letter. For example, if the user indicates that they reside in a state that does not allow for the use of memorandums to distribute personal property outside of the last will and testament, the section and option to create or revise a personal property memorandum will not be displayed to the user during the Letter completion process.

Screen 503 on FIG. 5C illustrates another example question in the “About Me” Section. This question queries whether the user(s) are eligible for Social Security. This, like the other questions, uses the user's response to determine which additional questions are asked and what content goes into the final Letter. For example, if the user indicates that they are not eligible for Social Security, they will not be asked where they store their Social Security card and their Letter will not include information for their surviving family about claiming Social Security death benefits.

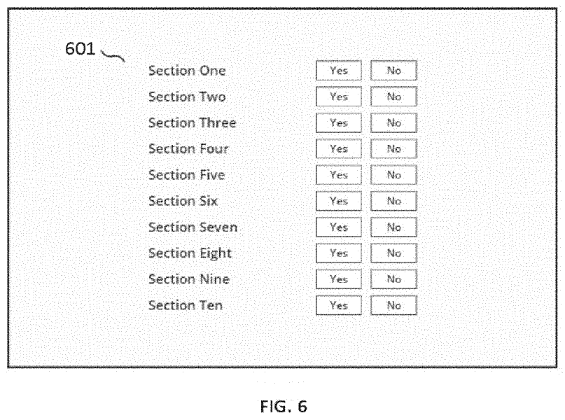

The section selector 601 according to the present disclosure is shown in FIG. 6. In this part, the user is prompted to select which topical sections they want to be included in the Letter. These topical sections are optional and cover a range of different topics. These sections can include, but are not limited to, directions and information regarding funeral arrangements; the location of important documents (e.g., last will and testament, insurance policies, financial statements); a summary of financial accounts and insurance policies; the identification of potential assets and liabilities of the estate; details regarding real and intangible property; contact information for professional service providers (e.g., lawyer, accountant, financial planner) and other points of contact; if permitted by the last will and testament and applicable law, a listing of certain personal property for disposition; directions regarding the access, use and disposition of electronic assets (e.g., computer files, email, online accounts, social media, online photo libraries and backups); directions regarding the care of any pets; guidance regarding the care of any dependents; notifications or instructions; and a final message to family and/or friends. If no optional sections are selected, then the Letter will only include the default, mandatory sections.

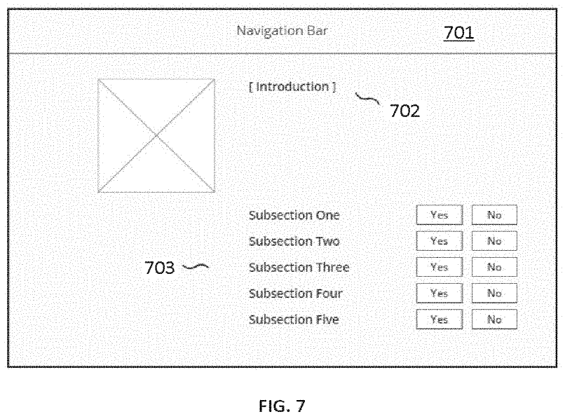

Screen 702 in FIG. 7 illustrates an example “Section Intro & Screening” layout where the user is provided information and instructions about the section in question. The subsection selector feature 703 can be included in each section. When included, this part also provides the user with the opportunity to select which subsections are included. These subsections address specific topics that are included in the overall section. Each section and subsection are tailored to each user based on a set of initial screening inputs and the user's responses or inputs to earlier sections or questions.

The navigation bar 701 according to the present disclosure is shown in FIG. 7. The navigation bar allows the user to navigate between the different sections that will be included in the Letter (i.e., sections excluded by the user are not displayed). The navigation bar is included in each section.

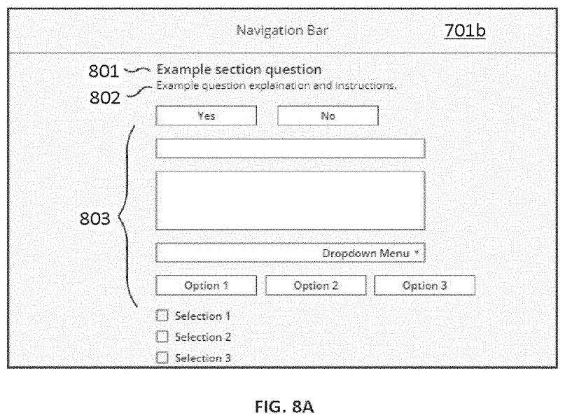

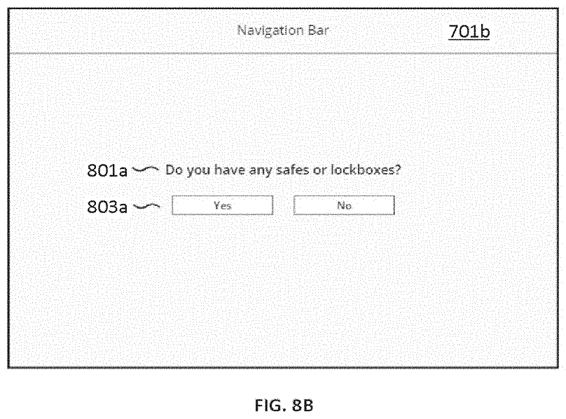

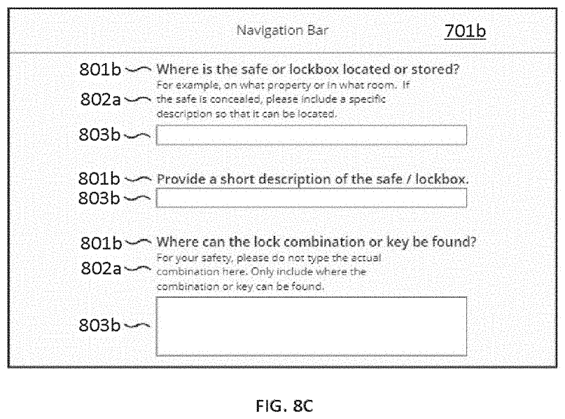

FIG. 8A shows an example “Section Questions” layout and shows non-exhaustive examples of different input fields. The questions may be structured one per page, multiple per page, or may be organized in one or more modals. Each section and set of queries are structured to alleviate the need for unnecessary interrogation. For example, if the user provides a certain input to a query, the system will change the subsequent queries to account for that earlier input. If the user does not know or have the requested input or does not want to provide a response, most queries can be skipped and answered later or omitted from the Letter. Once submitted to the system by the user, the input(s) are encrypted to protect its confidentiality and integrity.

The system uses a proprietary and dynamic query-based decision engine to determine how the user navigates through the system, which sections and questions are displayed, and what and how content is rendered in the final Letter. This decision engine is driven by the user's interactions with the system, including their responses to queries and other user inputs. Each user input field may have numerous, unique, logic rules to dictate how the system interacts with the user and, ultimately, how the system compiles the final Letter. Questions are generally broken down to address an isolated aspect of the section so that the user's input can be fed into the system's decision engine. For example, the sample question that is illustrated in FIG. 8B is predicated on multiple, different, logic rules that are built into the system: (1) this example question resides in the Personal Property section, if the user had not selected to include this section in their Letter, this section and question would have never been displayed to the user; (2) if the user answers in the negative (i.e., I do not have any safes/lockboxes), they would automatically be taken to the next applicable section or question, and the related content relevant to safes/lockboxes would be omitted from their final Letter; (3) if the user answers in the affirmative (i.e., I do have a safe/lockbox), they would be displayed with an option to add information about those safes and/or lockboxes in their Letter; (4) if the user elects not to add this information, they would be automatically taken to the next applicable section or question; (5) if the user opts to add this information, the system would display a modal with additional, relevant questions (represented in FIG. 8C) that allows the user to provide information about the safes/lockboxes' location, a description of it, and a description of where the combination or key can be found (with an admonition not to include the actual combination in this field); and (5) if information is added by the user, then this information is processed and rendered in the Personal Property section of their final Letter and, in addition, an entry is added to a password sheet that is created within the final Letter so that the user can record the combination to the safe/lockbox without saving that more sensitive password information in the electronic version of their Letter. The foregoing describes the methodology of the dynamic query-based decision engine for a single query in a single section. The system includes hundreds of predefined queries (with the capability to add more) and includes hundreds of associated logic rules. This dynamic query-based system is used to guide the user in the creation of a customized Letter, and is designed to surface relevant areas of inquiry and suppress irrelevant or unwanted content.

Number 801 in FIG. 8A is an example section question. Number 802 is an example section explanation and instructions field which would provide background information to aid the user in answering the question and/or provide directions that are specific to this particular question. Number 803 are non-exhaustive examples of different types of input fields. The input fields come in many different forms including, but not limited to, fixed selections (e.g., yes, no or option 1, option 2, or option 3), single-line text input, multiple line text input, drop-down selections, multiple choice, address book, date selectors, numerical inputs, and the ability to upload different media (e.g., files, documents, images). In each section, the questions are sequenced one after another.

FIG. 8B illustrates an example question from a Personal Property section of the Letter completion process. This example questions illustrates one part of the system's decision engine. The user's response will determine what comes next in the process. In this particular question, if the user answers “Yes” they will be taken to the next section that will allow them to capture additional relevant information about their safes or lockboxes, see FIG. 8C. Each user input field may have several different logic rules to dictate how the system interacts with the user and compiles the final Letter. Number 801a is the text for the particular question and number 803a is the particular input fields that are relevant to this question.

FIG. 8C illustrates the questions that would be displayed to the user that answered FIG. 8B in the affirmative. Numbers 801b are the text for said question, numbers 802a are the explanation or instruction text that goes with each question (note, this is not included for every question, only when needed), and numbers 803b are the user input fields for said question. There can be a single question or multiple questions per screen, in some cases organized into multi-step modals. This example shows three questions that are all related to FIG. 8B.

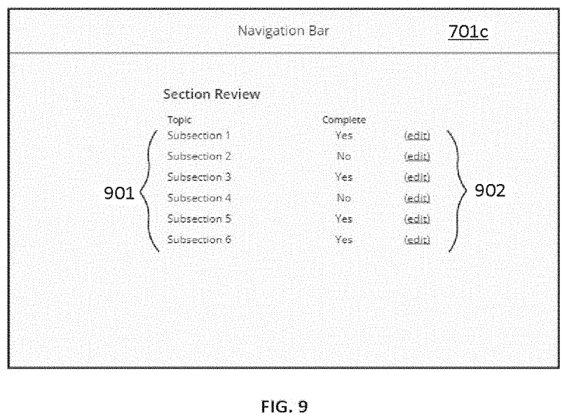

FIG. 9 illustrates an example “Section Review” layout for the review that takes place at the conclusion of each section. The system reviews the user's inputs to identify whether any subsections are incomplete or whether other errors or omissions are detected. Number 901 represents the display of the topical subsections and their review status. The user will have the ability to provide inputs to previously skipped or incomplete sections or questions. Number 902 is the functionality that allows the user to edit or update the responses as a result of the review feature.

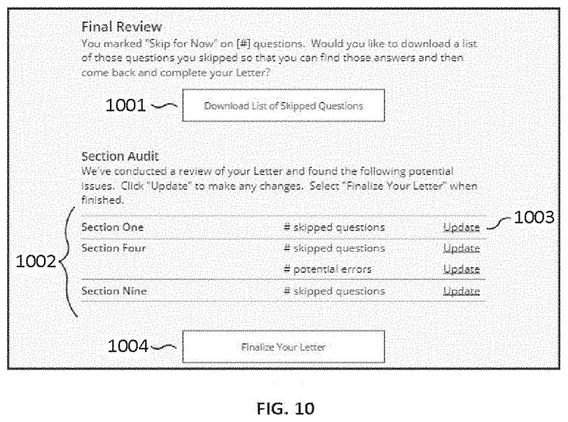

FIG. 10 illustrates an example “Final Review & Audit” layout of the final review and audit that takes place after all sections are completed but before the user finishes the Letter. Number 1001 is the feature that allows the user to download the skipped questions. The user is able to take this list, gather the missing information, and return to the system to input the information. Prior to the completion of the Letter, the system will run an audit process to help the user identify and correct potentially missing or incorrect inputs before generating a final Letter. Similar to FIG. 9, number 1002 is the final audit feature that shows any errors or omissions discovered during its audit of the completed sections. Number 1003 is the feature that allows the user to edit or update the responses as a result of the final audit.

The finalize Letter feature 1004 according to the present disclosure is shown in FIG. 10. Once the user has completed (or skipped, if so desired) the final review and audit and selects “Finalize Your Letter,” the system will analyze the various inputs across all of the sections and will generate a customized Letter for the user using a proprietary format. The final Letter organizes the user's inputs into a more productive form and combines the user's inputs with additional content from the system that instructs and informs the recipient of the Letter. Each final Letter is unique based on the sections and subsections that the user completed and the specific inputs that the user has provided. Each Letter includes a set of instructions and a prioritized checklist to assist the recipient(s) of the Letter in the immediate aftermath of the user's or other subject's death. For example, the prioritized checklist includes recommended actions to take on the first day, first three days, first week, first month, and so on. Each checklist is customized based on the contents of the user's Letter and includes references to where additional related information can be found in the long-form Letter.

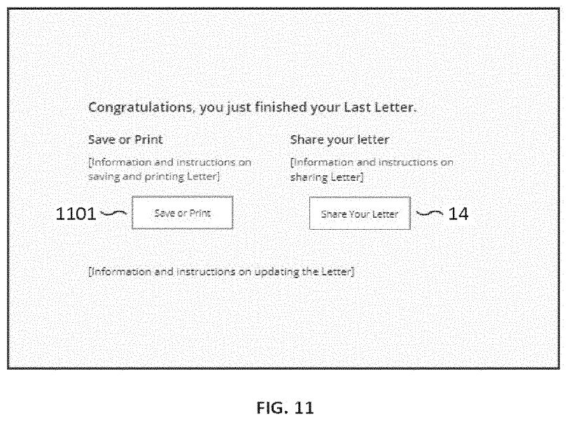

FIG. 11 illustrates an example “Finished Letter” layout where the user can save and/or print their final letter and start the process to add one or more viewers. Users are also given several options on how they can convey their final Letter to someone else; users always have the option to keep the Letter private. Number 1101 is the feature that allows the user to print and/or save an electronic copy of their final Letter. They can share this electronic or printed copy or keep it in a location that is likely to be found at the time of their passing.

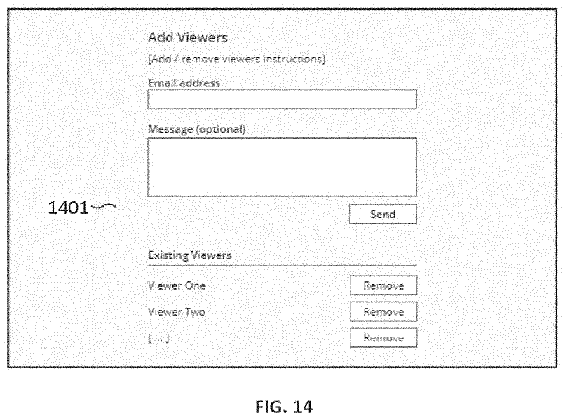

Number 14 (see also FIG. 14) shows the user's ability to share a read-only version of the final Letter with one or more trusted individuals. The users have two methods to share the final Letter via the system. First, the user can designate one or more individuals (each a “viewer” and collectively the “viewers”) who have the ability to view a read-only version of the final Letter in the system. These viewers have near real-time access to the most current version of the Letter. A user can add or remove viewers at any time. Secondarily, the system will support the ability to generate unique alphanumeric codes (“access code”) that will be provided to the user or transmitted at the direction of the user to give a third party access to the then-current Letter upon the user's death. Access codes can be used by the recipient to create an identity in the system to access a read-only version of the Letter. Each access code is single use to prevent multiple individuals from using the same access code. To help mitigate the risk that a recipient of an access code will access the Letter before instructed by the user, the user will be sent a notification every time that an access code is used to create an account to access the Letter.

In addition, at the final stage of the Letter creation process the system may also match the user with and display third-party products and services based on needs or opportunities identified during the Letter creation process.

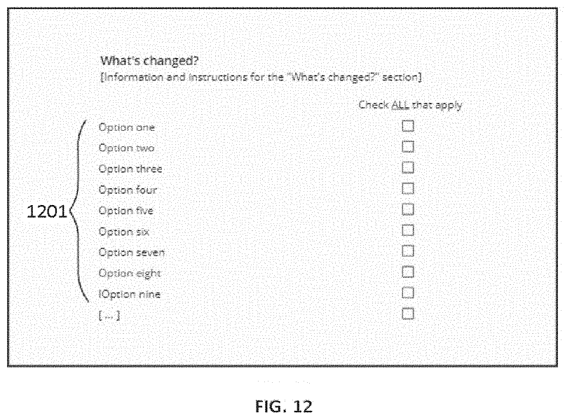

FIG. 12 illustrates an example “What's changed” layout where the user can indicate certain changes during the Letter update process (see, FIG. 3). For each update, the user will go through a guided process to determine what information has changed. Those selections by the user allow the system to determine which sections, subsections, and queries to display for the user during the update process. For example, if the user indicates they have gotten married, the system will ask if they want to add their spouse to the Letter and prompt them with related questions. This aspect helps to ensure that the user does not need to repeat aspects of the Letter that have not changed.

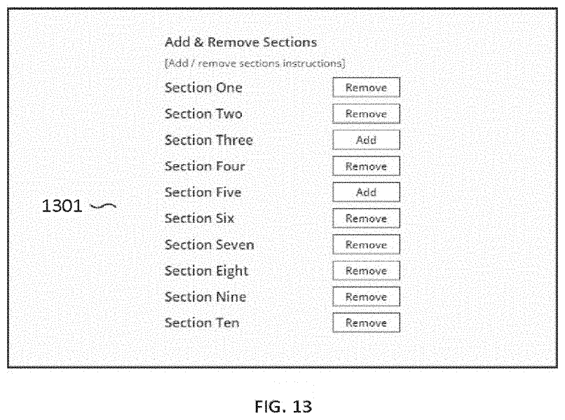

FIG. 13 illustrates an example “Add/Remove Sections” layout where the user can add new sections or remove existing sections during the Letter update process (see, FIG. 3). Like the section selector in FIG. 6, number 1301 is the feature that allows the user to remove existing sections or add new sections. In conjunction with FIG. 12, this aspect allows the system to determine which subsections and queries should be added or removed. Like with the initial creation of the Letter, users will have the discretion to skip or not answer specific questions. The information from the last version of the Letter is stored in the system so that it does not need to be re-entered if it is still accurate. Other than FIG. 12 and FIG. 13, the process to update or revise a Letter is similar to the initial Letter creation process.

The add viewers feature 1401 according to the present disclosure is shown in FIG. 14. FIG. 14 illustrates how users can add or remove viewers. Upon completion by the user, each new viewer will receive an invitation message from the system with a mechanism to create an identity in the system. This identity allows the viewers to view all of the Letters that they have been provided access to. The viewers may not modify any Letter without the user's permission. If the user updates the Letter, each of the authorized viewers will have near real-time access to the most current version of the Letter. This feature helps to ensure that those trusted individuals always have access to the current information and preferences contained within the Letter. A user can add or remove a viewer or viewers at any time.

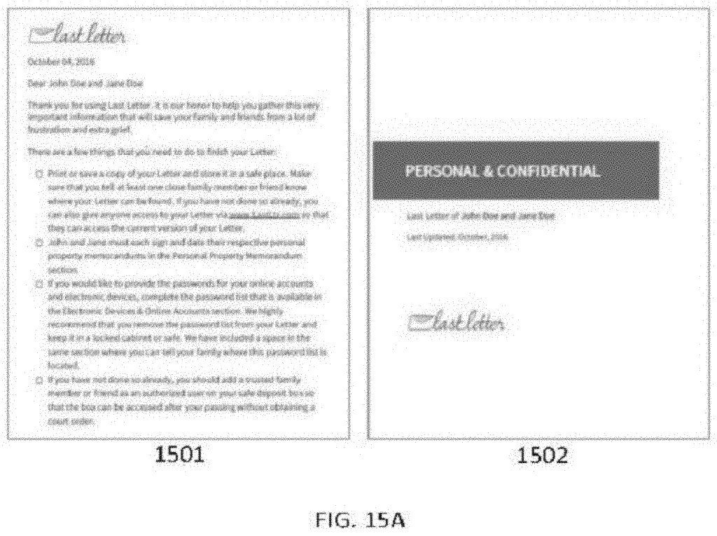

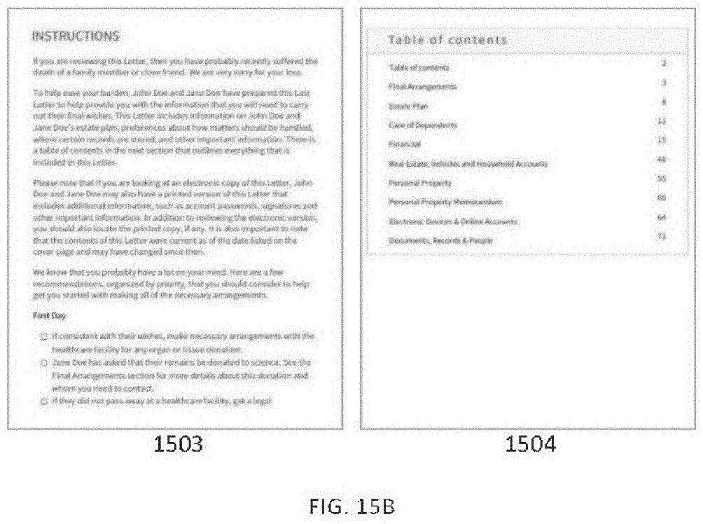

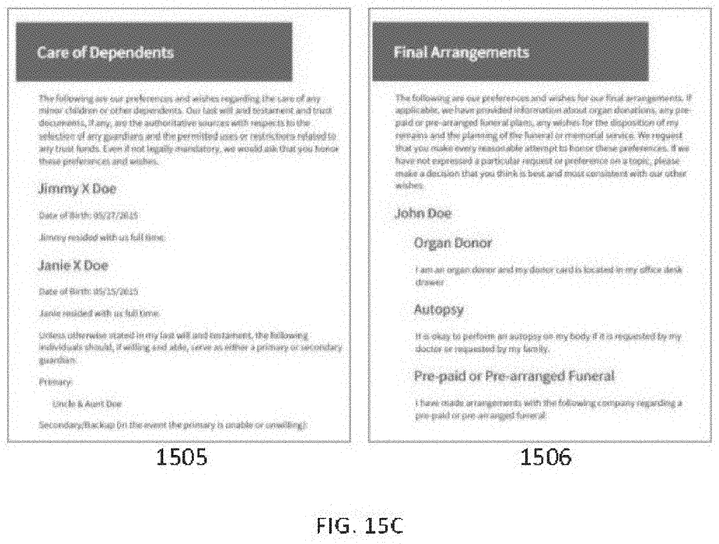

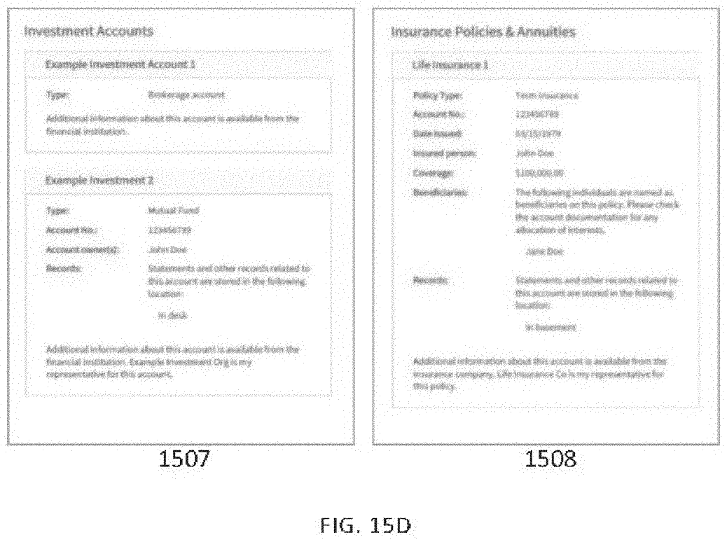

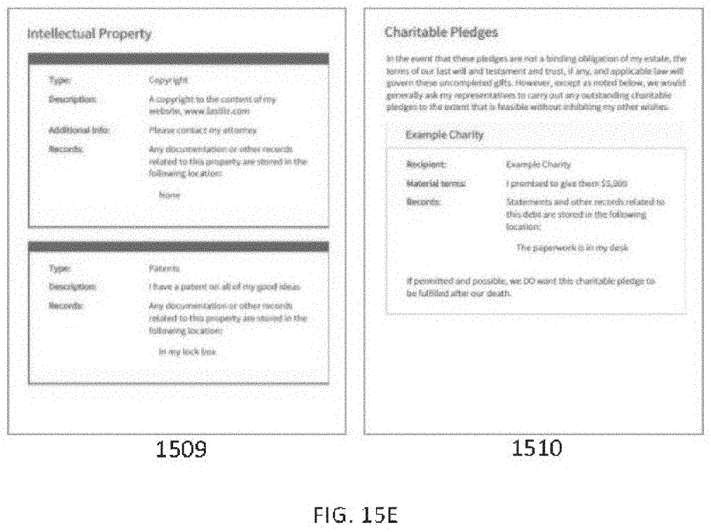

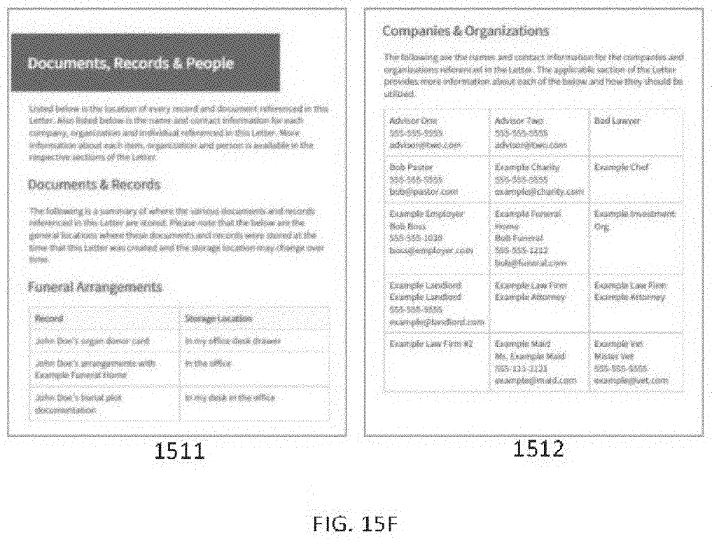

FIGS. 15A-15F include representative pages from a compiled, final Letter. Note, this sample does not include any actual user data and does not represent every section or page of a completed Letter. The final Letter organizes the user's inputs into a more productive form and combines the user's inputs with additional content from the system that instructs and informs the recipient of the Letter. Each final Letter is unique based on the sections and subsections that the user completed and the specific inputs that the user provided. Each Letter includes a set of instructions and a prioritized checklist to assist the recipient(s) of the Letter in the immediate aftermath of the user's or other subject's death. The sample pages (pages 1501-1512) are described below.

Figure reference numbers include:
Number 14 is is the selection option to share the final Letter;
Number 401 is the user type selection option;
Number 501 are examples of different question formats for the “About Me” layout;
Number 502 is an example of a specific question from the “About Me” section;
Number 503 is a second example of a specific question from the “About Me” section;
Number 601 is the example section selector;
Number 701 is the navigation bar;
Number 702 is the example section introduction and information feature;
Number 703 is an example subsection selector feature;
Number 801 is an example section question;
Number 801a and 801b are examples of specific questions found in one section;
Number 802 is an example section explanation and instructions;
Number 802a are examples of specific question explanation and instructions;
Number 803 are non-exhaustive examples of different types of input fields;
Number 803a and 803b are examples of specific input fields found in one section;
Number 901 is the section review feature;
Number 902 is the feature that allows the user to edit or update their responses as a result of the review feature;
Number 1001 is the feature that allows the user to download the skipped questions;
Number 1002 is the final audit feature;
Number 1003 is the feature that allows the user to edit or update their responses as a result of the final audit;
Number 1004 is the finalize Letter feature;
Number 1101 is the Letter save and/or print option;
Number 1201 is the “What's changed” feature in the letter update process;
Number 1301 is the feature that allows the user to remove existing sections or add new sections during the Letter update process;
Number 1401 is the is the feature to add or remove “viewers;”
Number 1501 is an example of the first page from the instructions to the creator section in a final Letter, these instructions precede the long-form Letter;
Number 1502 is an example of the cover page of a final Letter;
Number 1503 is an example of the first page from the instructions to the recipient and checklist section in a final Letter;
Number 1504 is an example of the table of contents in a final Letter;
Number 1505 is an example of a page from the instructions for dependents section in a final Letter;
Number 1506 is an example of a page from the final arrangements section in a final Letter;
Number 1507 is an example of a page from the assets section detailing certain investment accounts in a final Letter;
Number 1508 is an example a page from the assets section detailing certain insurance policies in a final Letter;
Number 1509 is an example of a page from the assets section detailing certain intellectual property in a final Letter;
Number 1510 is an example of a page from the charitable pledges information in a final Letter;
Number 1511 is an example of a page from the documents, records and people section in a final Letter; and
Number 1512 is an example of a page from the contacts section in a final Letter.

While the embodiments herein disclosed has been described by means of specific embodiments and applications thereof, numerous modifications and variations could be made thereto by those skilled in the art without departing from the scope of the disclosure.

What is claimed is:

1. A method for collecting, organizing and conveying information and preferences regarding certain end-of-life issues comprising:
providing a dynamic query-based system that guides a user to create a customized final output;
soliciting a first set of inputs from the user that relate to a user type, information about a subject of the output, and a selection of topics to be included in the output;
generating a first set of topical sections and queries included in each section based on the first set of inputs solicited from the user;
soliciting a second set of inputs in response to the first set of topical sections and queries;
executing a decision engine to dynamically determine a second set of sections and queries based on the second set of inputs;
soliciting a third set of inputs in response to the second set of sections and queries;
generating the final output that organizes the first, second and third inputs solicited from the user, and combining the inputs with content and instructions; and
providing the user with the ability to print, download, or save the final output or to share the final output with a third party.

2. The method of claim 1, wherein the content in the final output relates to the user or another individual.

3. The method of claim 2, wherein the individual is selected from the group consisting of a family member, spouse, friend, dependent, or client.

4. The method of claim 1, wherein the user can selectively allow access to the final output to one or more individuals.

5. The method of claim 1, wherein the user can selectively add or remove information contained in the final output.

6. The method of claim 1, wherein the decision engine includes one or more unique logic rules that are used to determines the second set of sections and queries and wherein the decision engine is used to generate the final output.

7. The method of claim 1 wherein one or more subjects of the first and second sections are selected from the group consisting of estate plan, location of important documents, a summary of financial accounts and insurance policies, identification of potential assets and liabilities of the estate, details regarding real and intangible property, contact information for professional service providers, a list of certain personal property for disposition; directions regarding access, use and disposition of electronic assets, directions regarding the care of any pets, guidance regarding the care of any dependents, notifications or instructions, and a final message to family and/or friend.

8. The method of claim 1 wherein the user enters the first, second, and third sets of inputs using fields selected from the group consisting of, including fixed selections, single-line text inputs, multi-line text inputs, drop-down selections, multiple choice, address book, date selectors, numerical inputs, and the ability to upload different electronic media which are organized on a single screen, multiple screens or multi-step modals.

9. A method for generating a custom checklist for the administration of the estate, certain end-of-life issues and final arrangements comprising:
soliciting inputs from the user that related to estate planning, end-of-life issues, final arrangements, and other related matters;
generating a first set of topical sections and queries based on one or more decisions, one or more responses, and the inputs solicited from the user;
executing a decision engine to dynamically determine a second set of sections and queries included in a second set of sections based on the user's responses to the first set of queries and the inputs solicited from the user;
generating an output that organizes the inputs solicited from the user's responses to the first and second set of sections and queries, and combining the inputs and responses with content and instructions; and
providing the user with the ability to print, download, or save the final output or to share the final output with a third party.

10. The method of claim 9, wherein items included in said output are prioritized based on which items need to be addressed in relation to time intervals following a person's death.

11. The method of claim 9 wherein the user can selectively allow access to the final output to one or more individuals.

12. The method of claim 9 wherein the user can selectively add or remove information contained in the final output.

13. A method for auditing information and preferences regarding certain end-of-life issues comprising:
reviewing inputs solicited from a user to identify whether an entry is incomplete or whether errors or omission are detected; and
providing the user with an opportunity to correct, enter, supplement or revise missing, incomplete or inaccurate entries.

14. The method of claim 13, further comprising generating a list of incomplete questions for the user to collect and input.
